(19) United States
(12) Patent Application Publication
(10) Pub. No.: US 2020/0042876 A1
(43) Pub. Date: Feb. 6, 2020

(54) COMPUTER-READABLE RECORDING MEDIUM RECORDING ESTIMATION PROGRAM, ESTIMATION METHOD, AND INFORMATION PROCESSING DEVICE

(71) Applicant: FUJITSU LIMITED, Kawasaki-shi (JP)

(72) Inventors: TAKASHI KATOH, Kawasaki (JP); Kento UEMURA, Kawasaki (JP); Suguru YASUTOMI, Kawasaki (JP); Toshio Endoh, Yokohama (JP); Koji MARUHASHI, Hachioji (JP)

(73) Assignee: FUJITSU LIMITED, Kawasaki-shi (JP)

(21) Appl. No.: 16/653,236

(22) Filed: Oct. 15, 2019

Related U.S. Application Data
(63) Continuation of application No. PCT/JP2018/016379, filed on Apr. 20, 2018.

(30) Foreign Application Priority Data
May 16, 2017 (JP) 2017-097669

(51) Int. Cl. G06N 3/08; G06K 9/62; G05B 23/02

(52) U.S. Cl. CPC G06N 3/08; G05B 23/0281; G06K 9/6256

(57) ABSTRACT

A non-transitory computer-readable recording medium records an estimation program causing a computer to execute processing which includes: calculating a reconfiguration error from an input result value and a reconfiguration value that is estimated by a first estimator, which estimates a parameter value from a result value learned on a basis of past data, and a second estimator, which estimates a result value from a parameter value, by using a specific result value or a neighborhood result value in a neighborhood of the specific result value; searching for a first result value that minimizes a sum of a substitute error that is calculated from the input result value and the specific result value and the reconfiguration error; and outputting a parameter value that is estimated from the first result value by using the first estimator.

### CROSS-REFERENCE TO RELATED APPLICATION

This application is a continuation application of International Application PCT/JP2018/016379 filed on Apr. 20, 2018 and designated the U.S., the entire contents of which are incorporated herein by reference. The International Application PCT/JP2018/016379 is based upon and claims the benefit of priority of the prior Japanese Patent Application No. 2017-097669, filed on May 16, 2017, the entire contents of which are incorporated herein by reference.

### FIELD

The present embodiment relates to an estimation program, an estimation method, and an estimation device.

### BACKGROUND

Simulation techniques that search for an input parameter (x) for realizing a certain state (y) have conventionally been used in various fields such as disaster analysis and personalized medicine.

Related art is disclosed in Japanese Laid-open Patent Publication No. 2011-185880, Japanese Laid-open Patent Publication No. 2016-8564 and Japanese Laid-open Patent Publication No. 2004-62440.

### SUMMARY

According to an aspect of the embodiments, a non-transitory computer-readable recording medium records an estimation program causing a computer to execute processing which includes: calculating a reconfiguration error from an input result value and a reconfiguration value that is estimated by a first estimator, which estimates a parameter value from a result value learned on a basis of past data, and a second estimator, which estimates a result value from a parameter value, by using a specific result value or a neighborhood result value in a neighborhood of the specific result value; searching for a first result value that minimizes a sum of a substitute error that is calculated from the input result value and the specific result value and the reconfiguration error; and outputting a parameter value that is estimated from the first result value by using the first estimator.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating a functional configuration of a simulation device according to a first embodiment.

FIG. 2 is a diagram illustrating an example of training data stored in a training data DB.

FIG. 3 is a diagram illustrating an example of test data stored in a test data DB.

FIG. 4 is a diagram describing a relationship between assumed training data and test data.

FIG. 5 is a diagram describing learning of estimators.

FIG. 6 is a diagram describing a simulation,

FIG. 7 is a diagram describing calculation of a reconfiguration error.

FIG. 8 is a diagram describing generation of substitute data.

FIG. g is a diagram describing a simulation according to the first embodiment.

FIG. 10 is a flowchart illustrating a flow of processing.

FIG. 11 is a diagram describing comparison of estimated values.

FIG. 12 is a diagram describing other examples of learning of the estimators.

FIG. 13 is a diagram illustrating an example of a hardware configuration.

### DESCRIPTION OF EMBODIMENTS

For example, a set of input and output that is an execution result of a past simulation is used as training data, and an estimator is learned that estimates an input from an output. Then, using the estimator learned, an input (x) is estimated that outputs a desired output (y).

However, in a case where a desired value is away from the training data and deviates from a range that can be estimated by the estimator, estimation accuracy is degraded.

For example, in a case where a parameter (x) is estimated that causes an extreme situation (y) such as a flood, it is likely that the extreme situation (y) is not included in past simulation results, and in such a case, the parameter (x) estimated becomes far from the training data, and reliability decreases. In addition, in a case where a parameter (x) is estimated whose output (y) matches actual data, the actual data is not necessarily included in a range that can be realized by a simulator, and may deviate from the training data. Note that, it is conceivable to prepare various and huge training data in advance, but it is very time-consuming and unrealistic.

In one aspect, an estimation program, estimation method, and estimation device capable of improving the estimation accuracy may be provided.

Hereinafter, embodiments will be described of an estimation program, estimation method, and estimation device disclosed in the present application in detail with reference to the drawings. Note that, the present invention is not limited to the embodiments, and the embodiments can be appropriately combined within the scope of no contradiction.

### First Embodiment

A simulation device 10 according to a first embodiment is a computer device for estimating an input corresponding to a certain output with high accuracy with respect to a black box function such as a simulator. For example, the simulation device 10 is used for estimation of a parameter that causes an extreme situation such as a flood that is not included in past simulation results, estimation of a parameter whose output matches actual data, or the like.

Generally, when considered as a simple prediction problem of an input parameter of a simulator, a simulation is executed aiming to minimize an error of a prediction result (x) with respect to an output (y). However, in practice, an error of an estimated parameter (x) is not important, and it is important to minimize an error between a prediction target (y) and a result s(x) in a case where the (x) is applied to the simulator.

The simulation device 10 according to the first embodiment therefore does not estimate data that is originally intended to be estimated, but instead estimates similar data within a range that can be accurately estimated. Specifically, the simulation device 10 does not directly solve a problem of estimating an actual estimation target (y), but solves the problem by replacing it to a problem of estimating another (y′) that can be estimated from training data and is as close as possible to the (y). For example, the simulation device 10 performs estimation of an error (application error) in a case where a certain input (x) is applied to a black box function s(x). Then, the simulation device 10 estimates an input (x) with respect to substitute data (y′) instead of the actual estimation target (y), the substitute data (y′) existing in a range where it is estimated that the application error is small and being a neighborhood value in the neighborhood of the (y).

In other words, the simulation device 10 uses together learning of an estimator that estimates the output from the input and learning of an estimator that estimates the input from the output, to estimate a range of the output that can be estimated accurately, whereby degradation of estimation accuracy is suppressed even in a case where a desired value is away from a set of the training data and deviates from a range that can be estimated by the estimator.

Functional Configuration

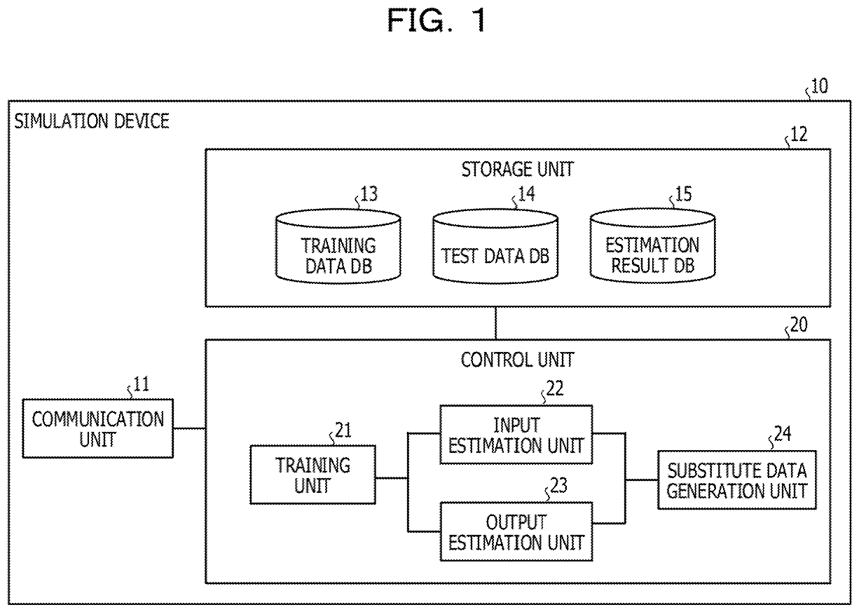

FIG. 1 is a functional block diagram illustrating a functional configuration of the simulation device 10 according to the first embodiment. As illustrated in FIG. 1, the simulation device 10 includes a communication unit 11, a storage unit 12, and a control unit 20. Note that, in addition to these units, the simulation device 10 may include a display unit, an input unit, and the like.

The communication unit 11 is a processing unit that controls communication between other devices, and is, for example, a communication interface, or the like. For example, the communication unit 11 receives an instruction to start processing from an administrator terminal or the like, accepts an input of the training data and test data, and transmits an estimation result to the administrator terminal.

The storage unit 12 is an example of a storage device that stores programs and data, and is, for example, a memory, a hard disk, or the like. The storage unit 12 stores a training data DB 13, a test data DB 14, and an estimation result DB 15.

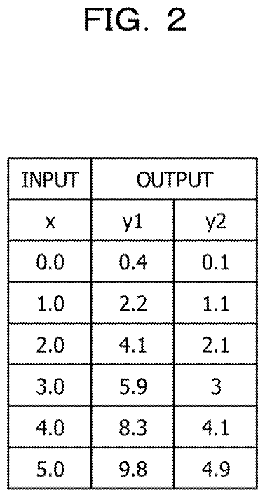

The training data DB 13 is a database that stores, as the training data, a set of input and output that is an execution result of a past simulation, FIG. 2 is a diagram illustrating an example of the training data stored in the training data DB 13. As illustrated in FIG. 2, the training data DB 13 stores “input, output (y1, y2)”. The “input” is an input to a black box function (s(x)) that is an unknown function such as a simulator, and the “output” is an output when an input (x) is input to the black box function. The example of FIG. 2 illustrates that a simulation result is (y1=0.4, y2=0.1) when x=0.0 is input to the black box function (s(x)). Note that, although the black box function (s(x)) is an unknown function, for example, “y1=2x+ε, y2=x+ε, ε is noise” or the like is assumed.

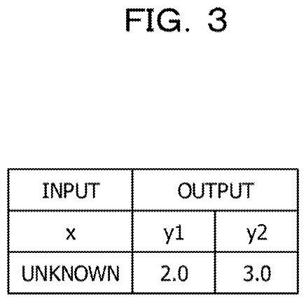

The test data DB 14 is a database that stores assumed actual data. FIG. 3 is a diagram illustrating an example of the test data stored in the test data DB 14. As illustrated in FIG. 3, the test data DB 14 stores “input, output (y1, y2)”. The “input” is a value of an input for obtaining an output, and the “output” is an output when the input is input to the black box function. As illustrated in FIG. 3, since the output is known and the input is unknown, here, the training data generated from the black box function (s(x)) is learned, and an input (x) is obtained that generates an output (y1, y2) as close as possible to the test data.

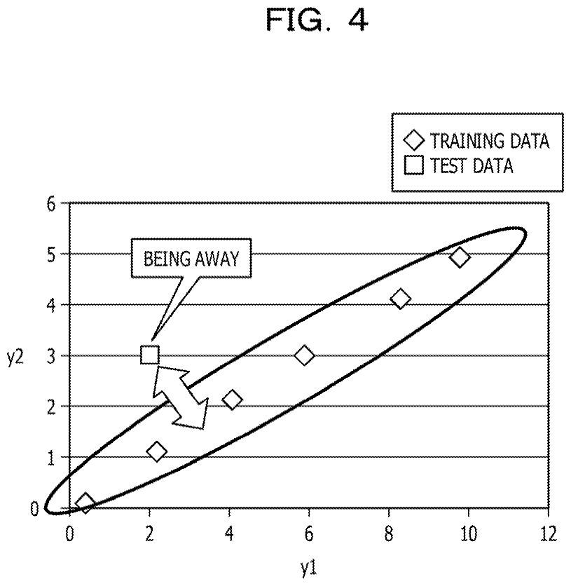

Here, a relationship will be described between the training data and test data assumed in the first embodiment. FIG. 4 is a diagram describing the relationship between the assumed training data and test data. As illustrated in FIG. 4, the test data is an output value away from the distribution of the training data, Since the test data deviates from the range that can be estimated by the estimator, the test data is therefore a value by which the estimation accuracy is degraded even when a simulation is executed by a conventional method.

The estimation result DB 15 is a database that stores an estimation result by the control unit 20 described later. For example, the estimation result DB 15 stores an estimated value of an input estimator enc(y1, y2) when a total error described later is less than a threshold value.

The control unit 20 is a processing unit that controls the entire simulation device 10, and is, for example, a processor, or the like. The control unit 20 includes a training unit 21, an input estimation unit 22, an output estimation unit 23, and a substitute data generation unit 24. Note that, the training unit 21, the input estimation unit 22, the output estimation unit 23, and the substitute data generation unit 24 each are an example of an electronic circuit included in the processor, or an example of a process executed by the processor. In addition, the substitute data generation unit 24 is an example of a calculation unit, a search unit, and an output unit.

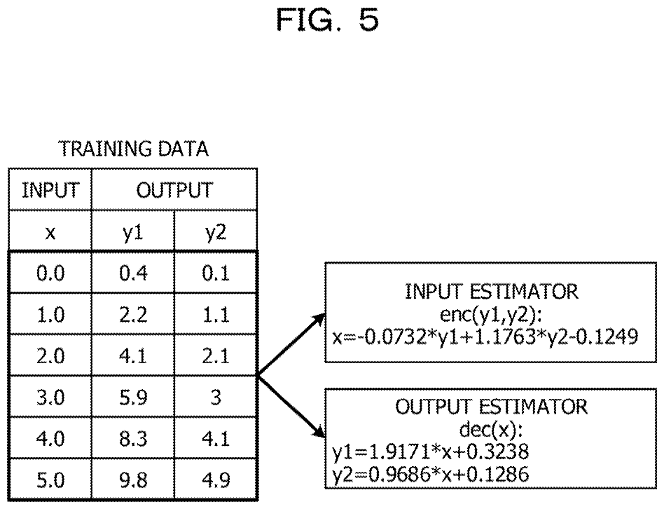

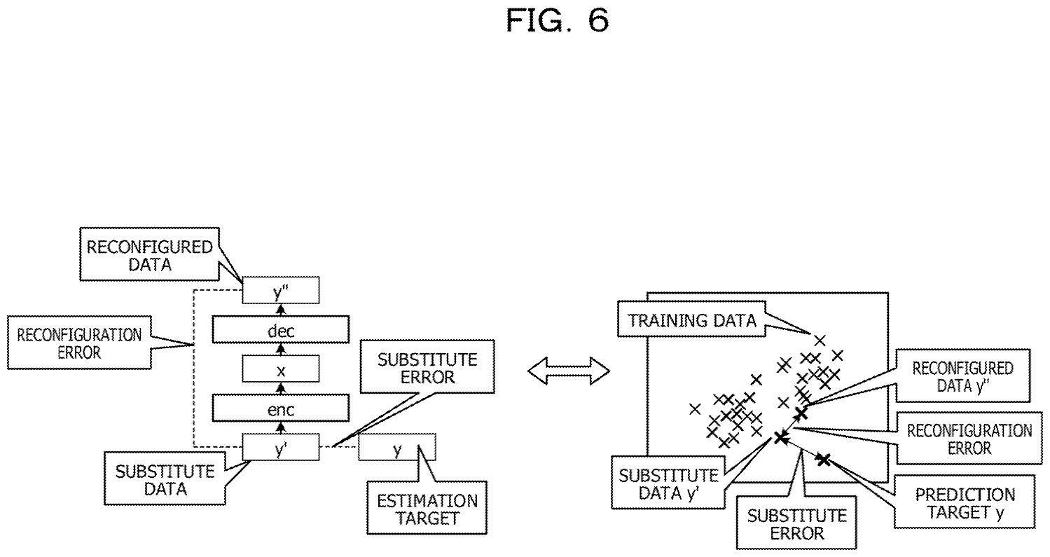

The training unit 21 is a processing unit that learns an input estimator enc(y) by using the training data and learns an output estimator dec(x) by using the training data. FIG. 5 is a diagram describing learning of the estimators. As illustrated in FIG. 5, the training unit 21 assigns an output (y1, y2) of the training data stored in the training data DB 13 to the input estimator enc(y1, y2), to learn an input (x). In addition, the training unit 21 assigns an input (x) of the training data stored in the training data DB 13 to the output estimator dec(x), to learn an output (y1, y2). Note that, in the first embodiment, a linear learner (simple perceptron) is used as each estimator; however, not limited thereto, a well-known various learners can be adopted.

The input estimation unit 22 is a processing unit that estimates an input (x) from an output (y) by using the input estimator enc(y). For example, the input estimation unit 22 applies an output (y1, y2) of the test data to the estimator enc(y) learned by the training unit 21, to estimate an input (x). Then, the input estimation unit 22 outputs the input (x) estimated to the output estimation unit 23.

The output estimation unit 23 is a processing unit that estimates an output (y) from an input (x) by using the output estimator dec(x). For example, the output estimation unit 23 applies the (x) input from the input estimation unit 22 to the estimator dec(x) learned by the training unit 21, to estimate an output (y). Then, the output estimation unit 23 outputs the output (y) estimated to the substitute data generation unit 24.

The substitute data generation unit 24 is a processing unit that generates substitute data (y) instead of an actual estimation target (y), the substitute data (y′) existing in a range where it is estimated that an error (application error) is small, and inputs the substitute data (y′) to the input estimation unit 22. In addition, the substitute data generation unit 24 is a processing unit that obtains, by optimization, the substitute data (y′) that minimizes a sum total (total error) of a substitute error that is a difference between the actual estimation target (y) and the substitute data (y′), and a reconfiguration error that is a difference between the (y′) and (y″) reconfigured from the (y′).

Simulation Processing

Here, a simulation according to the first embodiment will be described. FIG. 6 is a diagram describing the simulation. As illustrated in the left diagram of FIG. 6, the substitute data generation unit 24 estimates substitute data (y′) having a small substitute error that is an error from an estimation target (y), and inputs the estimated data to the input estimation unit 22. The input estimation unit 22 applies the input substitute data (y′) to the learned estimator enc(y), to estimate an input (x). Further, the output estimation unit 23 applies the estimated input (x) to the teamed estimator dec(x), to estimate an output (y″).

Then, the substitute data generation unit 24 calculates a reconfiguration error that is a difference between the substitute data (y′), and the reconfigured data (y″=dec(enc(y′))) estimated by the estimator dec(x). Subsequently, the substitute data generation unit 24 calculates a total error that is a total of the substitute error and the reconfiguration error. Thereafter, in a case where the total error does not converge, the substitute data generation unit 24 calculates new substitute data (y′) that makes the total error smaller, and again repeats estimation by the estimator enc(y) and the estimator dec(x). Then, in a case where the total error converges, the substitute data generation unit 24 outputs the (x) at that time as an estimation result.

Note that, the simulation device 10 according to the first embodiment does not aim to minimize an error of the input (x), but aims to minimize an error (total error is its estimation) of a result s(enc(y)) of applying the estimated enc(y) to the simulator, so that the estimation target y may be changed.

Here, a relationship between each piece of data and the error will be described. As illustrated in the right diagram of FIG. 6, data (y) that is a prediction target is data at a position away from training data. A dec(x) is therefore estimated by use of substitute data (y′) closer to the training data than the prediction target (y), and reconfigured data (y″=dec(enc(y′))) is estimated by use of the dec(x). Here, a distance between the prediction target (y) and the substitute data (y′) (for example, Euclidean distance) is a substitute error, and a distance between the substitute data (y′) and the reconfigured data (y″) is a reconfiguration error.

Calculation of Reconfiguration Error

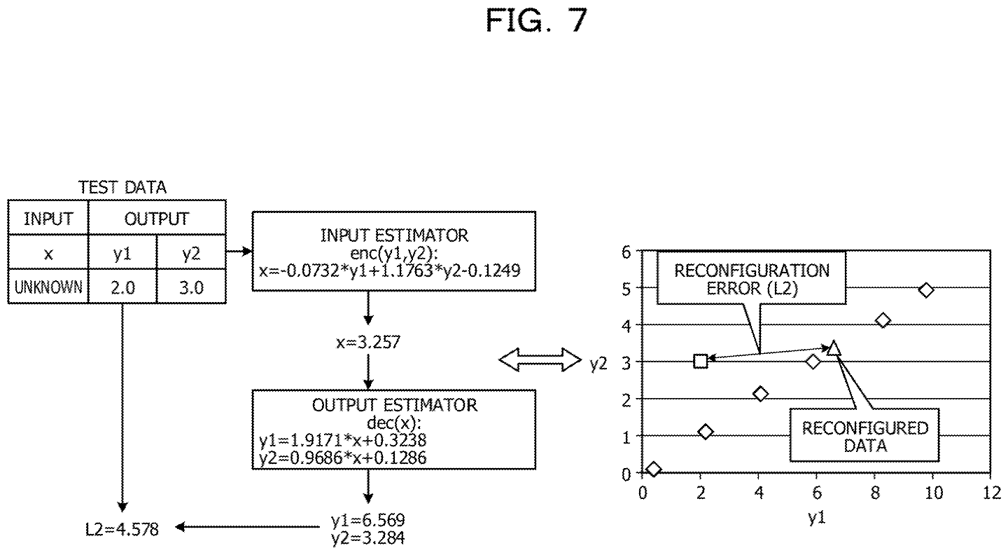

Next, a method of calculation of a reconfiguration error will be described. FIG. 7 is a diagram describing the calculation of the reconfiguration error. As illustrated in FIG. 7, the input estimation unit 22 applies the input estimator enc(y) to the output (y1, y2) of the test data, to estimate an input (x). For example, the input estimation unit 22 calculates the input (x=3.257) by using the learning result “x=−0.00732*y1+1.1763*y2−0.1249”.

Subsequently, the output estimation unit 23 applies the input (x) to the estimator dec(x), to estimate an output (y1, y2). For example, the output estimation unit 23 calculates the output (y1=6.569, y2=3.284) by using the learning result “y1=1.9171*x+0.3238, y2=0.9686*x+0.1286”.

Then, the substitute data generation unit 24 calculates 4.578 that is the Euclidean distance between the output (y1, y2) of the test data and the estimation result (y1=6.569, y2=3.284), as a reconfiguration error (L2). Then, the substitute data generation unit 24 generates substitute data and causes each estimator to execute estimation processing until the reconfiguration error (L2) becomes less than or equal to a threshold value.

Generation of Substitute Data

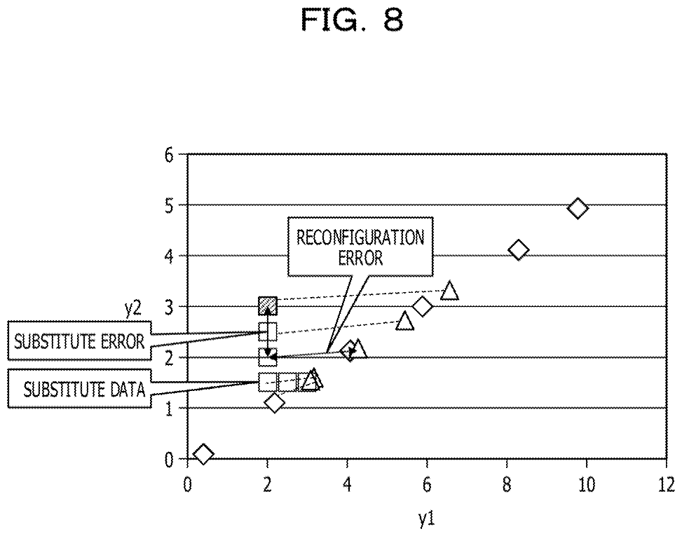

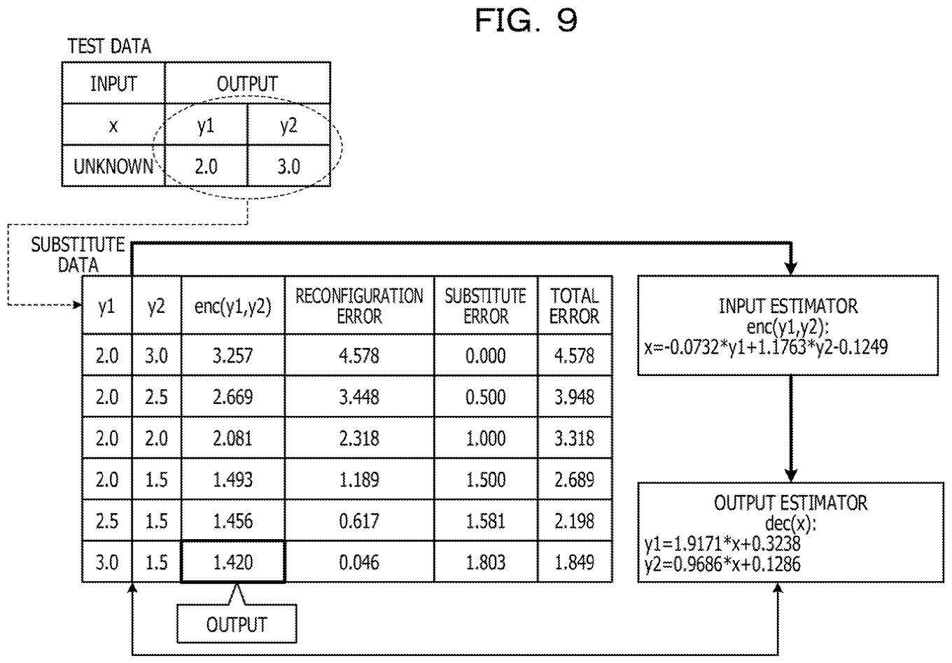

Subsequently, generation of substitute data will be described. FIG. 8 is a diagram describing generation of the substitute data. Rhombuses illustrated in FIG. 8 indicate training data, a shaded square indicates test data (initial value), white squares indicate substitute data, and triangles indicate reconfigured data. The substitute data generation unit 24 executes the simulation (estimation processing) by changing the value (substitute data) from the test data (initial value) so that the total error becomes smaller obtained by adding the substitute error and the reconfiguration error.

Here, the substitute data generation unit 24 obtains, by optimization, substitute data (y′) that minimizes the sum total (total error) of a difference (substitute error) between the actual estimation target (y) and the substitute data (y′), and a difference (reconfiguration error) between the substitute data (y′) and the reconfigured data (y″) reconfigured from the substitute data (y′).

For example, in a case where the total number of the training data is small at less than or equal to a threshold value, and the estimation accuracy of the substitute error is considered to be insufficient, the substitute data generation unit 24 can also use, for calculation of the total error, a weighted sum in which the weight of the reconfiguration error is reduced. More specifically, the substitute data generation unit 24 can also calculate the total error by reducing the weight of the reconfiguration error, such as estimation error+0.8*recombination error=total error.

In addition, in a case where the estimator enc and the estimator dec each are configured as a differentiable function such as a neural network, the substitute data generation unit 24 can also optimize the substitute data (y′) by using the gradient of the total error with respect to the (y′). More specifically, when the total error is L=f(y), in a case where the enc and the dec each are configured as a differentiable function such as a neural network, the f is differentiable. In this case, for a certain y, a small value (generally a vector) to be added to the y can be obtained to reduce the L By using this property, starting from an appropriate y, the gradient of the total error L with respect to the y is obtained, and the y is sequentially moved in the downward direction of the gradient, whereby the y with a small L can be efficiently obtained. As a method of using such a gradient (gradient method), an update equation of the re-steep descent method can be used, but update equations of various other methods can be used.

### Specific Example

Next, a specific example of the simulation will be described. FIG. 9 is a diagram describing the simulation according to the first embodiment. As illustrated in FIG. 9, first, the input estimation unit 22 applies the input estimator enc(y) to the output y (y1=2.0, y2=3.0) of the test data to estimate the input (x)=3.257, and the output estimation unit 23 applies the input (x) to the estimator dec(x) to estimate an output y″ (y1, y2). As a result, the substitute data generation unit 24 calculates the reconfiguration error (4.578) and the substitute error (0) of the output y and the output y″, and calculates the total error (4.578).

Here, since the total error (4.578) is greater than or equal to a threshold value (for example, 2), the substitute data generation unit 24 generates the substitute data y′ (y1=2.0, y2=2.5) to reduce the reconfiguration error by using the method described above. Then, the input estimation unit 22 applies the input estimator enc(y) to the substitute data y′ (y1=2.0, y2=2.5) to estimate the input (x)=2.559, and the output estimation unit 23 applies the input (x) to the estimator dec(x) to estimate an output y″ (y1, y2). As a result, the substitute data generation unit 24 calculates the reconfiguration error (3.448) and the substitute error (0.500) of the output y′ and the output y″, and calculates the total error (3.948).

Thus, the substitute data generation unit 24 sequentially generates substitute data and repeats estimation by each estimator until the total error is less than the threshold value. Then, when the substitute data y′ is (y1=3.0, y2=1.5), the total error is 1.849 and becomes less than the threshold value, so that the estimated value “1.420” of the input estimator enc(y1, y2) at this time is output to the estimation result DB 15 as the estimation result. Note that, in a case where it is known that the test data is data far from the training data, it is also possible that the substitute data is first generated after the processing starts without execution of estimation using the test data, and then the estimation using the substitute data is started.

Flow of Processing

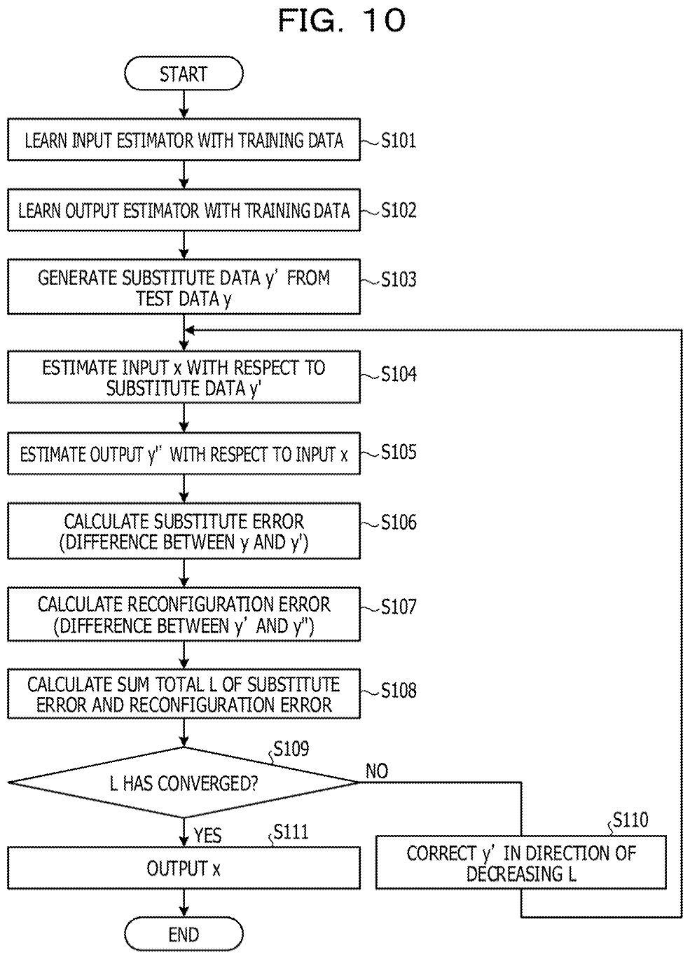

FIG. 10 is a flowchart illustrating a flow of the processing. As illustrated in FIG. 10, the training unit 21 learns the input estimator enc by using the training data (S101), and learns the output estimator dec by using the training data (S102).

Thereafter, the substitute data generation unit 24 generates the substitute data y′ from the test data y (S103). Then, the input estimation unit 22 estimates the input x with respect to the substitute data y′ by using the input estimator enc(y) (S104), and the output estimator 23 estimates the y″ with respect to the input x by using the output estimator dec(x) (S105).

Thereafter, the substitute data generation unit 24 calculates the substitute error that is the difference between the y and the y′ (S106), and calculates the reconfiguration error that is the difference between the y′ and the y″ (S107). Then, the substitute data generation unit 24 calculates a sum total L of the substitute error and the reconfiguration error (S108), and in a case where the L does not converge (S109: No), corrects the substitute data y′ in the direction of decreasing the L (S110) and then S104 and the subsequent steps are executed.

On the other hand, in a case where the L has converged (S109: Yes), the substitute data generation unit 24 outputs the x at that time (S111).

Effects

As described above, in the estimation method for estimating the parameter value from the result value by using the estimator, in a case where the value in the neighborhood of the result value can be used, the simulation device 10 can estimate the parameter value by using the neighborhood value with which the estimation accuracy is high. In other words, the simulation device 10 can estimate the range of the output that can be accurately estimated by using the learning of estimating the output from the input together with the learning of estimating the input from the output, and the estimation with respect to outliers becomes robust, and the estimation accuracy can be improved.

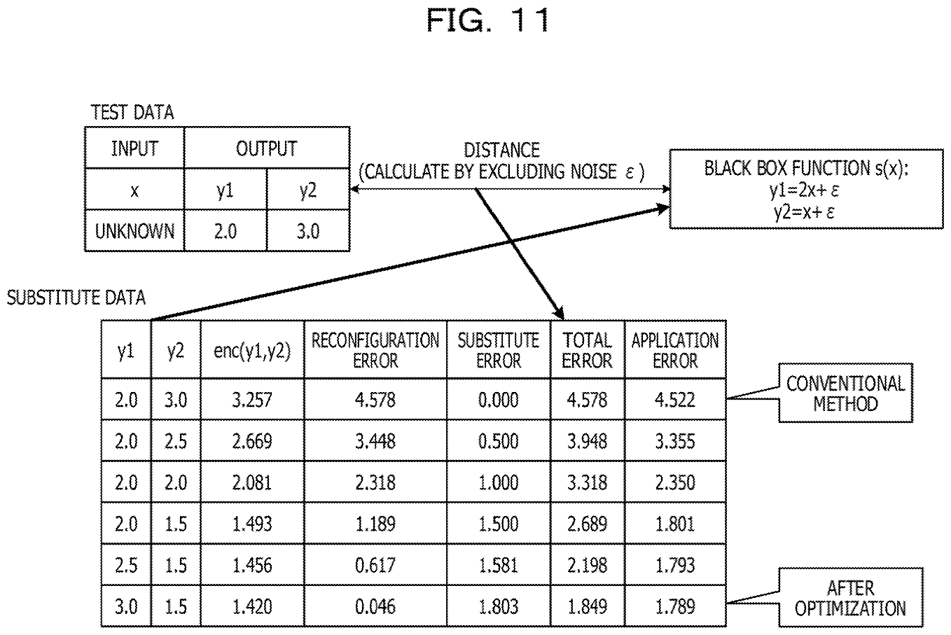

FIG. 11 is a diagram describing comparison of estimated values. As illustrated in FIG. 11, the simulation device 10 outputs a value closer to the test data when the black box function is applied to the test data away from the training data than in a case the input estimated value is simply used. That is, the application error obtained by excluding noise from the total error of the estimation result using the test data (y1=2.0, y2=3.0) is 4.522. On the other hand, in the case of the estimation result using the substitute data sequentially generated from the test data, the application error can be finally reduced to 1.789, and the accuracy is improved as compared with the general method.

That is, in a case where parameter estimation is performed that causes an extreme situation such as a flood included in past simulation results, the estimation accuracy decreases even if the extreme situation is estimated as it is as in the general method, but the decrease in estimation accuracy can be suppressed by estimation of an input (for example, rainfall) that causes a situation close to the flood.

### Second Embodiment

Although an embodiment of the present invention has been described above, the present invention may be implemented in various forms in addition to the above embodiment. A different embodiment will therefore be described below.

Learning of Estimator

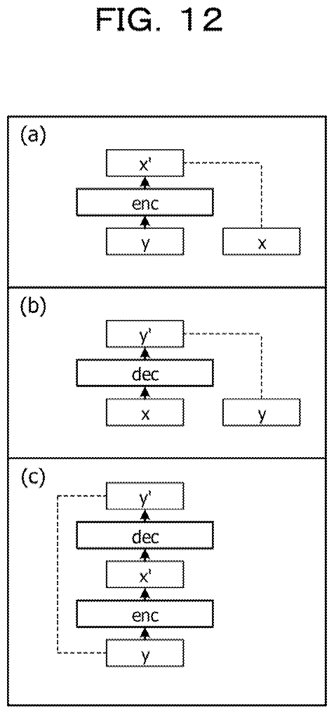

For example, the simulation device 10 can also learn the estimator enc and the estimator dec so that the reconfiguration error with respect to the training data is reduced at the time of learning, by using the AutoEncoder method. FIG. 12 is a diagram describing other examples of learning of the estimators. In the AutoEncoder method, two sets of training data can be used: (1) a set of the output y with respect to the input x, and (2) the output y with an unknown input (option).

As illustrated in FIG. 12, the simulation device 10 can therefore execute three types of learning. For example, as illustrated in (a) of FIG. 12, the simulation device 10 learns the estimator enc to reduce the error between the input estimated value x′=enc(y) with respect to the output y and the x, by using the data of (1). In addition, as illustrated in (b) of FIG. 12, the simulation device 10 learns the estimator dec to reduce the error between the estimated value y′=dec(x) of the output with respect to the input x and the y, by using the data of (1).

In addition, as illustrated in (c) of FIG. 12, the simulation device 10 learns the estimator enc and the estimator dec to reduce the error between the output estimated value y=dec(x′)=dec(enc(y)) with respect to the input estimated value x′=enc(y) with respect to the output y and the y, by using the data of the y of (1) and (2). By doing this, the simulation device 10 can further improve the estimation accuracy.

Generation of Substitute Data

For example, the simulation device 10 can generate substitute data by using various methods other than the method described above. For example, the simulation device 10 can express a set of training data as a straight fine by using an approximate value, an average value, or the like, and generate substitute data so that test data approaches the straight line.

System

Pieces of information including the processing procedure, control procedure, specific name, various types of data and parameters described above in the document or illustrated in the drawings may be changed in any ways unless otherwise specified.

In addition, each component of each device illustrated in the drawings is functionally conceptual, and thus the devices do not have to be physically configured as illustrated in the drawings. In other words, a specific form of distribution and integration of each of the devices is not limited to that illustrated in the drawings. That is, all or a part thereof may be configured by being functionally or physically distributed/integrated in any units depending on various loads, usage situations, and the like. Further, all or any part of each processing function performed by each device may be realized by a CPU and a program analyzed and executed by the CPU, or may be realized as hardware using wired logic.

Hardware Configuration

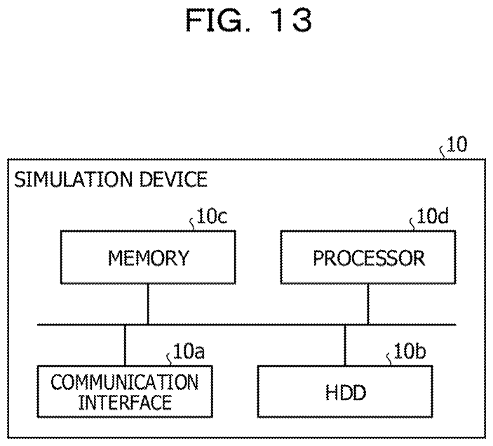

FIG. 13 is a diagram illustrating an example of a hardware configuration. As illustrated in FIG. 13, the simulation device 10 includes a communication interface 10a, a hard disk drive (HDD) 10b, a memory 10c, and a processor 10d.

The communication interface 10a is a network interface card or the like that controls communication of another device. The HDD 10b is an example of a storage device that stores programs, data, and the like.

Examples of the memory 10c include a random access memory (RAM) such as a synchronous dynamic random access memory (SDRAM), a read only memory (ROM), and a flash memory. Examples of the processor 10d include a central processing unit (CPU), a digital signal processor (DSP), a field programmable gate array (FPGA), and a programmable logic device (PLD).

In addition, the simulation device 10 operates as an information processing device that executes an estimation method by reading and executing a program. That is, the simulation device 10 executes a program that executes functions similar to the training unit 21, the input estimation unit 22, the output estimation unit 23, and the substitute data generation unit 24. As a result, the simulation device 10 can execute a process that executes the functions similar to the training unit 21, the input estimation unit 22, the output estimation unit 23, and the substitute data generation unit 24. Note that, this program referred to in other embodiments is not limited to being executed by the simulation device 10. For example, the present invention can be similarly applied to a case where another computer or server executes the program, or a case where such computer and server cooperatively execute the program.

This program can be distributed via a network such as the Internet. In addition, this program is recorded on a computer-readable recording medium such as a hard disk, flexible disk (FD), CD-ROM, magneto-optical disk (MO), or digital versatile disc (DVD), and can be executed by being read from the recording medium by the computer.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium recording an estimation program causing a computer to execute processing, the processing comprising:
calculating a reconfiguration error from an input result value and a reconfiguration value that is estimated by a first estimator, which estimates a parameter value from a result value learned on a basis of past data, and a second estimator, which estimates a result value from a parameter value, by using a specific result value or a neighborhood result value in a neighborhood of the specific result value;
searching for a first result value that minimizes a sum of a substitute error that is calculated from the input result value and the specific result value and the reconfiguration error; and
outputting a parameter value that is estimated from the first result value by using the first estimator.

2. The non-transitory computer-readable recording medium according to claim 1, wherein in a case where a total number of the past data is less than or equal to a threshold value, a weight of the reconfiguration error is calculated to be smaller than a weight of the substitute error when the sum is calculated.

3. The non-transitory computer-readable recording medium according to claim 1, wherein in a case where the first estimator and the second estimator are an estimator that uses a neural network, the neighborhood result value in the neighborhood of the specific result value is searched for by using a gradient of a total error that is the sum of the reconfiguration error and the substitute error in the searching.

4. An estimation method comprising:
calculating, by a computer, a reconfiguration error from an input result value and a reconfiguration value that is estimated by a first estimator, which estimates a parameter value from a result value learned on a basis of past data, and a second estimator, which estimates a result value from a parameter value, by using a specific result value or a neighborhood result value in a neighborhood of the specific result value;
searching for a first result value that minimizes a sum of a substitute error that is calculated from the input result value and the specific result value and the reconfiguration error; and
outputting a parameter value that is estimated from the first result value by using the first estimator.

5. The estimation method according to claim 4, wherein in a case where a total number of the past data is less than or equal to a threshold value, a weight of the reconfiguration error is calculated to be smaller than a weight of the substitute error when the sum is calculated.

6. The estimation method according to claim 4, wherein in a case where the first estimator and the second estimator are an estimator that uses a neural network, the neighborhood result value in the neighborhood of the specific result value is searched for by using a gradient of a total error that is the sum of the reconfiguration error and the substitute error in the searching.

7. An information processing device comprising:
a memory; and
a processor coupled to the memory and configured to:
calculate a reconfiguration error from an input result value and a reconfiguration value that is estimated by a first estimator, which estimates a parameter value from a result value learned on a basis of past data, and a second estimator, which estimates a result value from a parameter value, by using a specific result value or a neighborhood result value in a neighborhood of the specific result value;
search for a first result value that minimizes a sum of a substitute error that is calculated from the input result value and the specific result value and the reconfiguration error; and
output a parameter value that is estimated from the first result value by using the first estimator.

8. The information processing device according to claim 7, wherein in a case where a total number of the past data is less than or equal to a threshold value, a weight of the reconfiguration error is calculated to be smaller than a weight of the substitute error when the sum is calculated.

9. The information processing device according to claim 7, wherein in a case where the first estimator and the second estimator are an estimator that uses a neural network, the neighborhood result value in the neighborhood of the specific result value is searched for by using a gradient of a total error that is the sum of the reconfiguration error and the substitute error in the searching.
